(19) United States
(12) Patent Application Publication
(10) Pub. No.: US 2009/0193947 A1
(43) Pub. Date: Aug. 6, 2009

(54) Multipurpose cutting tool

(76) Inventors: Dennis H. Hancock, Morgan, UT (US); Jeffrey D. Hancock, Uintah, UT (US)

Correspondence Address: Timothy B. Smith, Suite 800, 185 South State Street, Salt Lake City, UT, 84111, US

(21) Appl. No.: 12/322,192

(22) Filed: Jan. 31, 2009

Related U.S. Application Data
(60) Provisional application No. 61/063,375, filed on Feb. 1, 2008.

(51) Int. Cl. B23D 21/14; B26B 11/00

(52) U.S. Cl. 83/184; 30/125

(57) ABSTRACT

A multipurpose cutting tool comprising a multi-function handle housing with a multi-function blade that can be used in a variety of different ways to open a variety of different packages. The multipurpose cutting tool can be used to safely and easily open almost any product packaging.

### CROSS REFERENCE TO RELATED APPLICATION

This application claims the benefit of U.S. Provisional Application Ser. No. 61/063,375 filed Feb. 1, 2008 by Dennis H. Hancock and Jeffery D. Hancock.

### FIELD OF THE INVENTION

The present invention relates generally to cutting tools and more particularly a multipurpose cutting tool for opening a variety of packaging.

### BACKGROUND OF THE INVENTION

In order to address problems with shipping, storing, displaying, and preventing theft of merchandise, manufacturers and retailers have increasingly turned to the use of plastic packaging and packaging that is difficult to remove. This includes, but is not limited to, clam-shell plastic packaging, plastic wrapping and security tape around DVD and CD packages, and the use of twist ties, zip ties and screws to secure products within a package. The plastic used in clamshell packaging is strong, thick and frequently welded together at the edges. This packaging is often difficult to open, can cause injury and can lead a purchaser or recipient of a package to be consumed with “wrap rage”, especially on a Christmas morning or at a child's birthday party. There is not a simple way to open the packaging employed by manufacturers and retailers today. No longer is a pair of scissors or a utility knife sufficient to safely open the intricate packaging that encases most consumer products today. There is clearly a need for a device that will permit a user to safely and easily open many different kinds of packages with only one tool.

### SUMMARY OF THE INVENTION

To solve the problems with opening product packaging, we have designed an improved multi-purpose cutting tool. The invention incorporates a single multi-function blade with a multi-function handle structure that permits the user to use the device in a variety of ways. The single multi-function blade is spring-loaded within the multi-function handle. When used in the package opening position, the user depresses a blade extension button, which extends the blade slightly from the handle and is used to pierce plastic packaging, creating a small opening in the packaging. The button is then released and the user inserts the angled insertion tip of the device into the opening in the packaging. The tapered and staggered blade transition area and bind preventing cutting relief notch nose notch are specially engineered to avoid binding and to ensure that the nose of the device will move smoothly through the packaging. The blade is exposed only within a blade safety channel within the back throat cutting area of the nose and is moved away from the user in such a manner as to slice open the plastic packaging. The user is protected from the sharp edges of the plastic packaging by a downward diverting shelf and hand guard that ensure that the plastic will open away from the device. In this manner, a user can utilize the device to easily and safely open the packaging.

By grasping the handle of the device in a different manner, the user can use the device to open DVD or CD packaging. A small portion of the multi-function blade extends out from the handle within a cutting channel. The extended portion of the multi-function blade is covered by a protective spring loaded blade guard, which prevents the user from accidentally cutting themselves. The user inserts a DVD or CD into the cutting channel, applies slight pressure to depress the blade guard and moves the blade along the edges of the package to remove the plastic covering and security tape from the DVD or CD.

Often, a product is secured within cardboard packaging by zip ties, twist ties and/or screws. By grasping the device in yet a different manner, the user can utilize the tool compartment located at one end of the device. A number of tools are stored in the tool compartment. A pair of scissors/wire cutters can be used to cut through packaging, zip ties, twist ties and even paper. In addition to the scissors/wire cutters, the tool compartment contains a regular screwdriver and a Phillips head screwdriver, which can be used to remove screws that might be utilized in securing a product within the packaging or to open battery compartments on the products themselves.

By holding the handle of the device in yet a fourth manner, the user can sharpen knives with the knife sharpener portion of the device.

In one aspect of the invention, it provides a cutting tool for opening product packaging.

In another aspect of the invention, it provides a cutting tool for removing DVD and CD packaging.

In another aspect of the invention, it provides a means for removing zip ties, twist ties and screws securing a product within packaging.

In another aspect of the invention, it provides a means for opening a battery compartment in a product.

In another aspect of the invention, it provides a means for sharpening knives and other tools that require sharp edges.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 is a schematic view of the apparatus of the invention.

FIG. 2 is a schematic of the interior of the apparatus of the invention.

FIG. 3 is a perspective view of the apparatus of the invention.

FIG. 4 is a front view of the blade locking and extending mechanism of the invention.

FIG. 5 is a perspective view of the blade locking and extending mechanism of the invention

FIG. 6 is side view of the blade locking and extending mechanism of the invention

FIG. 7 is a side view of the multi-function blade of the invention.

FIG. 8 is a perspective view of the multi-function blade of the invention.

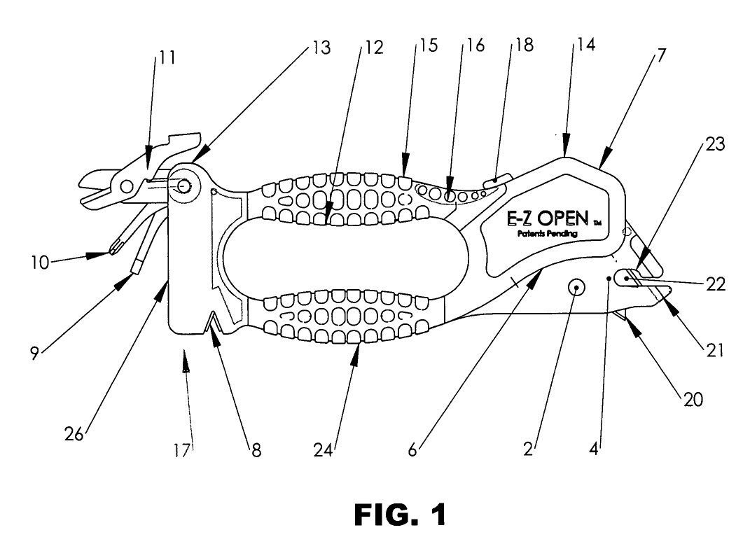

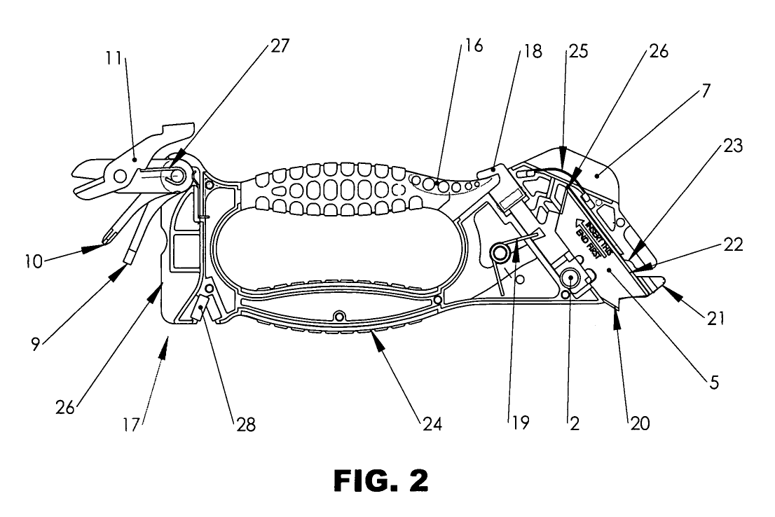

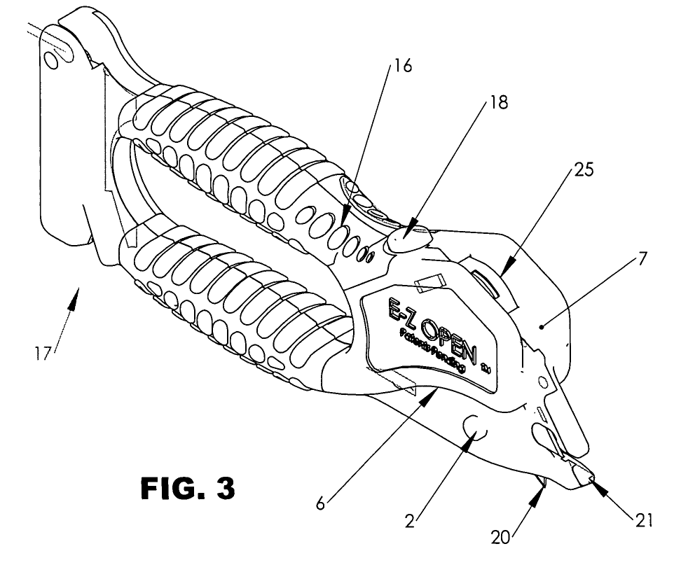

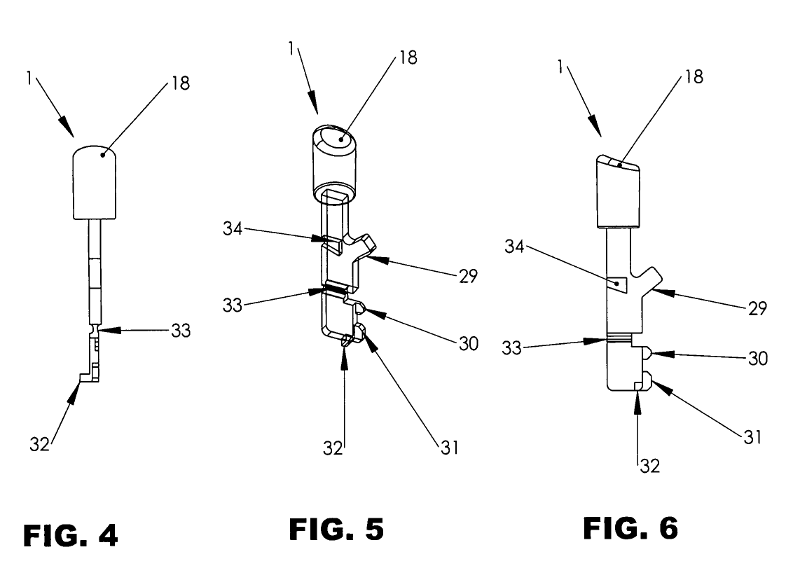

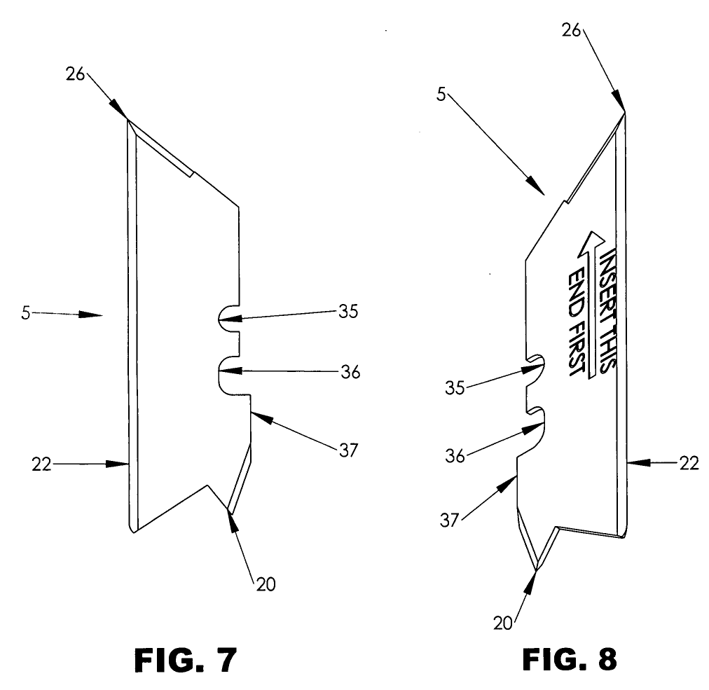

### DETAILED DESCRIPTION OF THE INVENTION

A user grips the packaging opening side 15 of handle 12 with their thumb on angled thumb rest 16, which promotes using multipurpose cutting tool 17 on an angle, making cutting easier. By depressing the contoured thumb button 18 of blade locking and extending mechanism 1, the user moves thumb button spring 19 and along with it multi-function blade 5 to the extended position exposing piercing cutting tip and edge 20 to facilitate the piercing of the packaging the user desires to open. After releasing blade contoured thumb button 18, piercing cutting tip and edge 20 of multi-function blade 5 retracts inside multipurpose cutting tool 17. The user then inserts angled insertion tip 21, which helps insure the optimum cutting angle, inside the hole created in the package by piercing cutting tip and edge 20. As multipurpose cutting tool 17 is moved along the packaging, the packaging is cut and separated by the slicing cutting edge 22 of multi-function blade 5, which is located within bind preventing relief notch 23. Tapered and staggered blade transition area 4 and bind preventing cutting relief notch 23 are designed to permit multipurpose cutting tool 17 to move easily through packaging without binding or jamming. The cut plastic packaging is diverted away from the user's hand by downward diverting shelf 6. The user's hand is further protected by the “dog bone” shape of handle 12.

By gripping the CD or DVD opening side 24 of handle 12, multipurpose cutting tool 17 can be used to open a CD or DVD or other similar package. The user places the package between DVD/CD safety guide rails 7. The user applies sufficient pressure to depress DVD/CD opening blade guard 25. This permits the use of the DVD/CD opener cutting tip 26 of multi-function blade 5. Because multi-function blade 5 is spring loaded within multipurpose cutting tool 17, DVD/CD opener cutting tip 26 will retract into multipurpose cutting tool 17 if excess pressure is applied to it. This promotes both safety for the user and prevents damage to the DVD or CD package. Multipurpose cutting tool 17 is then moved around the DVD/CD to slice open the plastic and security tape surrounding and protecting the product.

By gripping the packaging opening side 15 of handle 12 with their thumb opposite angled thumb rest 16, the user can utilize the tool compartment 26 of multipurpose cutting tool 17. Located within tool compartment 26 are regular screwdriver 9, Phillips screwdriver 10 and offset, high-leverage foldable cutting tool 11. Offset, high-leverage foldable cutting tool 11 can be used to cut a variety of things, including but not limited to, zip ties, twist ties, cables, cardboard and paper. Cutting tool spring 27 automatically returns offset, high-leverage foldable cutting tool 11 to the open position after cutting. Regular screwdriver 9 and Phillips screwdriver 10 can be used to remove screws that secure a product within a package as well as to open a battery compartment on a product contained within a package.

By gripping the CD or DVD opening side 24 of handle 12, multipurpose cutting tool 17 can be used to sharpen knives and other tools requiring a sharp edge. The user can rest multipurpose cutting tool 17 on flat base areas 13 and 14, which provide a stable base when the tool is inverted and placed on a flat surface for use as a knife sharpener. In that position, the user can utilize “V” shaped carbide knife sharpener 8, which is set into pockets 28.

If multi-function blade 5 becomes dull, it can be easily removed by depressing blade release button 2. Blade locking and extending mechanism 1 is comprised of contoured thumb button 18, blade support arm 29, small keyed blade lock 30, large keyed blade lock 31, blade stop 32, which prevents incorrect insertion of multi-function blade 5, flex channel 33, which when depressed by blade release button 2 disengages keyed blade locks 30 and 31 and releases multi-function blade 5 from handle 12. Spring notch 34 facilitates the extension and retraction of piercing cutting tip and edge 20 and the retraction of DVD/CD opener cutting tip 26.

Multi-function blade 5 allows for the use of a single blade in multipurpose cutting tool 17. Slicing/cutting edge 22 is used to slice open packaging, primarily plastic clamshell packaging, after an opening has been created in the packaging by piercing/cutting tip and edge 20. DVD/CD opener cutting tip 26 is used to open and remove plastic and security tape from a DVD or CD. Small keyed blade notch 35 and large keyed blade notch 36 are designed to match up with small keyed blade lock 30 and large keyed blade lock 31 to ensure that multi-function blade 5 is inserted correctly into multipurpose cutting tool 17. Multi-function blade 5 is also tapered and features widened blade area 37, which also serves to ensure that multi-function blade 5 is inserted correctly.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention.

What is claimed is:

1. A multipurpose cutting tool comprising:
a multi-function handle housing comprising, a cutting end, a gripping area and a tool end; and
a multi-function extendable and retractable blade.

2. A multipurpose cutting tool comprising:
a multi-function handle housing comprising, a cutting end, a gripping area and a tool end, said cutting end comprising an angled insertion tip, a bind preventing cutting relief notch and a tapered and staggered blade transition area, said tool end comprising tools that can be used to assist in opening a package or unscrewing and screwing a screw;
a multi-function extendable and retractable blade comprising a slicing/cutting edge, a piercing/cutting tip and edge, and a cutting tip.

3. The multipurpose cutting tool of claim 2 wherein the multi-function blade is replaceable,

4. The multi-purpose cutting tool of claim 3 wherein the multi-function blade is tapered to prevent incorrect insertion.

5. The multipurpose cutting tool of claim 3 wherein the multi-function blade contains blade notches to prevent incorrect insertion.

6. The multipurpose cutting tool of claim 3 wherein the blade is replaced by depressing a blade release button.

7. The multipurpose cutting tool of claim 2 wherein the multi-purpose blade is extended and retracted by a blade locking and extending mechanism.

8. The multipurpose cutting tool of claim 2 wherein the cutting tip is covered by a blade guard.

9. The multipurpose cutting tool of claim 2 wherein the tool end also comprises a knife sharpener.

10. A method of cutting packaging with a tool having a single blade comprising the steps of:
extending a portion of the single blade;
piercing and slicing open a portion of the packaging;
retracting the single blade;
inserting the tip of the tool into the opening crated by the single blade; and
sliding a cutting edge of the single blade against the packaging.

11. A method of removing plastic packaging surrounding a product with a tool having a single blade comprising the steps of:
placing the product against a blade guard with sufficient force to depress the blade guard and expose a cutting tip; and
moving the cutting tip of the tool around the package to cut the plastic surrounding it.
